(19) United States
(12) Patent Application Publication
(10) Pub. No.: US 2006/0197441 A1
(43) Pub. Date: Sep. 7, 2006

(54) Array substrates for electroluminescent displays and methods of forming the same

(76) Inventors: Yaw-Ming Tsai, Taichung Hsien (TW); Hsiu-Chun Hsieh, Changhua City (TW); Shih-Chang Chang, Hsinchu (TW)

Correspondence Address: Min, Hsieh & Hack LLP;c/o PortfoliolP, P.O. Box 52050, Minneapolis, MN, 55402, US

(21) Appl. No.: 11/071,746

(22) Filed: Mar. 3, 2005

(51) Int. Cl. H01J 1/62; H01J 63/04

(52) U.S. Cl. 313/506

(57) ABSTRACT

Array substrates for electroluminescent (EL) devices and methods of forming the same are disclosed. The array substrates for electroluminescent (EL) devices include a substrate with at least one thin film transistor formed thereon, covered by a planarization layer. A first dielectric passivation layer with a contact hole therein covers parts of the planarization layer and exposes a source/drain electrode of the thin film transistor. A transparent electrode covers a portion of the first electric passivation layer and fills the contact hole, and is partly exposed by a patterned second dielectric passivation formed thereon. A plurality of spacers covers a portion of the second dielectric passivation layer to define an organic electroluminescent area with an exposed transparent electrode. An organic electroluminescent layer covers the exposed transparent electrode, and an electrode covers the organic electroluminescent layer.

### FIELD OF THE INVENTION

The present invention relates to electroluminescence (EL) devices, and more particularly to array substrates for active matrix organic light emitting diodes.

### BACKGROUND OF THE INVENTION

The new generation of flat panel devices, electroluminescent displays, for example organic light emitting diode (OLED) displays, have self-luminescence, wide-viewing angle, thin profile, light weight, low driving voltage, and a simple manufacturing process. In OLED displays with a laminated structure, organic compounds such as dyes, polymers, or other luminescent materials serve as an organic luminescent layer and are disposed between a cathode and an anode. OLED displays can be classified as passive matrix and active matrix types, according their driving mode.

Active matrix OLEDs (AM-OLED) are driven by an electric current where each of the matrix-array pixel areas has at least one thin film transistor (TFT) that serves as a switch. The TFTs modulate the driving current based on the variation of capacitor storage potential so as to control the brightness and gray level of various pixel areas.

In an AM-OLED, an electric current is applied to a specific organic lamination to cause luminescence. The AM-OLED has panel luminescence with thin and lightweight characteristics, spontaneous luminescence with high luminance efficiency and low driving voltage, increased viewing angle, high contrast, rapid response, full color, and flexibility.

Indium tin oxide (ITO) has been widely used as an anode electrode material for AM-OLED applications due to its transparency, good conductivity, and high work function. However, the luminescent characteristics of an AM-OLED can depend on the surface roughness of the anode electrode. The surface roughness of the ITO film should be smooth enough to avoid large or unwanted leakage currents and/or point discharge which can cause pixel defects.

The average roughness of ITO films formed by sputtering deposition is less than 1 nm. Typically the ITO film is formed on an under-layer in an AM-OLED process, thereby the surface roughness of the ITO film depends strongly on different under-layers.

Generally, a transparent and insulating organic material is used as the under-layer in conventional AM-OLED process. However, the surface roughness of the ITO film on the organic materials is 3˜4 times larger than that on a smooth glass plate. For example, the average roughness (Ra) of an ITO film on organic materials is about 3˜4 nm. Such a rough surface may result in a large leakage current and can cause point discharge. As a result, the luminance efficiency and lifetime of the device are adversely affected.

Moreover, after formation of an insulating organic material, processes such as chemical vapor deposition (CVD) cannot be utilized due to, for example, a tool contamination. This limits the methods available for forming subsequent layers over the ITO film and increases costs for an AM-OLED.

### SUMMARY

Array substrates for electroluminescent (EL) devices and methods of forming the same are provided. An exemplary embodiment of an array substrate for an electroluminescent device comprises a substrate with at least one thin film transistor formed thereon. A planarization layer covers the substrate and the thin film transistor and a first dielectric passivation layer with a contact hole therein covers parts of the planarization layer to expose a source/drain electrode of the thin film transistor. A transparent electrode covers a portion of the first dielectric passviation layer and fills the contact hole. A second dielectric passivation layer covers a first portion of the transparent electrode and exposes a second portion of the transparent electrode. A plurality of spacers covers portions of the second dielectric passivation layer to define an organic electroluminescent area with an exposed transparent electrode. An organic electroluminescent layer covers the transparent electrode and the second dielectric passivation layer in the organic electroluminescent area and a metal electrode covers the organic electroluminescent layer.

An exemplary embodiment of a method of forming an array substrate for an electroluminescent display comprises providing a substrate with at least one thin film transistor thereon. A planarization layer is formed over the substrate and the thin film transistor. A first dielectric passivation layer is formed over the planarization layer with a contact hole therein, exposing a source/drain electrode of the thin film transistor. A transparent electrode is formed over the first dielectric passivation layer, filling the contact hole. A second dielectric passivation layer is formed over portions of the transparent electrode to expose a portion the transparent electrode. A plurality of spacers is formed on the second dielectric passivation layer defining an organic electroluminescent area with an exposed transparent electrode therein. An organic electroluminescent layer is formed over the exposed transparent electrode in the organic electroluminescent area and a metal electrode is formed over the organic electroluminescent layer.

A detailed description is given in the following with reference to the accompanying drawings.

### BRIEF DESCRIPTION OF THE DRAWINGS

The invention can be more fully understood by reading the subsequent detailed description and examples with reference made to the accompanying drawings, wherein:

FIGS. 1a to 1f are schematic cross section view showing an array substrate of an electroluminescent (EL) device according to various embodiments of the present invention;

FIG. 2 is a schematic view illustrating an embodiment of a display device of the present invention, incorporating the array substrate of FIG. 1f; and

FIG. 3 is a schematic diagram illustrating an electronic device incorporating an embodiment of a display device of the present invention.

### DESCRIPTION

Electroluminescent (EL) devices and methods of forming the same will now be described in greater detail. The present invention can prevent tool contamination during fabrication of electroluminescence devices and increase process flexibility of an EL device process. In some embodiments, the above can be accomplished by providing a dielectric layer under a transparent electrode, using an insulating organic layer thereunder, and/or reducing the surface roughness of the transparent electrode.

In this specification, expressions such as “overlying the substrate”, “above the layer”, or “on the film” denote a relative positional relationship with respect to the surface of the base layer, regardless of the existence of intermediate layers. Accordingly, these expressions may indicate not only the direct contact of layers, but also, a non-contact state of one or more laminated layers.

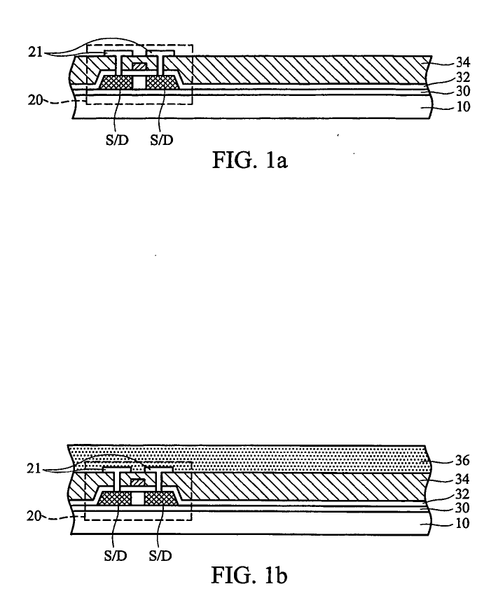

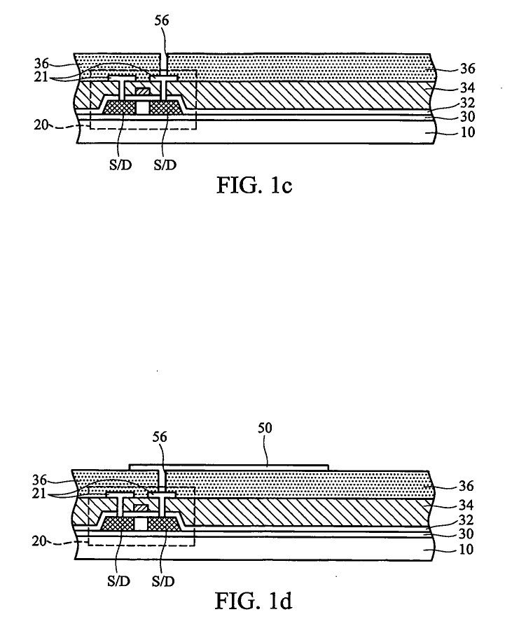

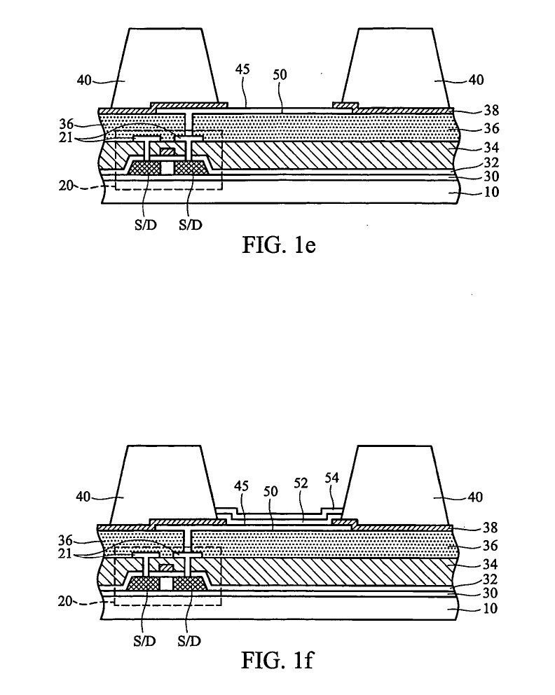

FIGS. 1a to 1f are cross sectional representations of methods for forming an array substrate for electroluminescent (EL) devices, according to embodiments disclosed herein.

In FIG. 1a, an array substrate comprising a substrate 10, a thin film transistor 20, a gate insulating layer 32, a buffer layer 30 and source/drains S/D is first provided. The thin film transistor 20 acts as a driving circuit for an AM-OLED. Next, a planarization layer 34 is formed, for example over the buffer layer 30 and the thin film transistor 20, for example, by sputtering, physical vapor deposition (PVD), chemical vapor deposition (CVD), or plasma enhanced chemical vapor deposition (PECVD). Source/drain electrodes 21 are respectively formed through the planarization layer 34 and the gate insulating layer 32 and electrically contact a source/drain region S/D of the thin film transistor 20. According to various embodiments, the substrate 10 comprises a transparent insulating material such as a glass, plastic, or ceramic substrate. A plastic substrate can comprise single or multiple layers of at least one of, for example, polyethylene terephthalate, polyester, polycarbonates, polyacrylates, or polystyrene. AM-OLEDs can include thin film transistors (TFT) such as amorphous-silicon thin film transistors (a-Si:H TFT), low temperature poly-silicon thin film transistors (LTPS-TFT), or organic thin film transistors (OTFT).

Suitable materials for the planarization layer 34 can include insulating oxides, nitrides, carbides or combinations thereof. Exemplary materials can include silicon nitride, silicon oxide, aluminum oxide, magnesium oxide, aluminum nitride, or magnesium fluoride. The source/drain electrode 21 can comprise a conductive layer such as a metal layer.

In FIG. 1b, a first passivation layer 36 is then formed on the planarization layer 34 and the source/drain electrodes 21. Exemplary materials of the first passivation layer 36 can comprise an insulating dielectric material, such as silicon oxide, silicon nitride, or combinations thereof. According to various embodiments, the materials of first passivation layer 36 have improved surface flatness over that of conventional organic materials. For example, the average surface flatness or Ra can be less than about 2.5 nm, and in certain cases, can be less than about 2.0 nm.

Next, in FIG. 1c, a first photoresist layer (not shown) with openings is formed and defined on the first passivation layer 36. The first passivation layer 36 is etched using the first photoresist layer as a mask. A contact hole 56 is thus formed to expose one of the source/drain regions S/D by etching the first passivation layer 36. The process of etching the first passivation layer 36 can include wet etching or dry etching.

In FIG. 1d, a transparent electrode 50 serving as the OLED anode electrode is formed on the surface of the first passivation layer 36. The transparent electrode 50 can also fill the contact hole 56 and contacts the source/drain electrode 21 of the thin film transistor 20. Suitable materials for the transparent electrode 50 include transparent metal or metal oxides, such as, indium tin oxide (ITO), indium zinc oxide (IZO), aluminum zinc oxide (AZO), or zinc oxide (ZnO) either singly or in combinations thereof. According to various embodiments, the transparent electrode 50 can be formed by a method such as sputtering, electron beam evaporation, thermal evaporation, or chemical vapor deposition.

In FIG. 1e, a second passivation layer 38 is formed conformally over the transparent electrode 50. Next, using photolithography and etching with a second resist pattern (not shown), the second passivation layer 38 is patterned to expose a portion of the transparent electrode 50 and define an organic electroluminescent area 45.

According to various embodiments, the material of the second passivation layer 38 can comprise an insulating dielectric material, such as silicon oxide, silicon nitride, or combinations thereof. According to various embodiments, the material of second passivation layer 38 also provides good surface flatness. For example, the average surface flatness or Ra can be less than about 2.5 nm, and in certain cases, can be less than about 2.0 nm.

Next, spacers 40 are formed on the second passivation layer 38 to more clearly define at least one predetermined organic electroluminescent area 45. Then, tri-color organic electroluminescent materials, such as red, green and blue color, can be formed isolated by spacers 40, the problem of color blending can be reduced. According to various embodiments, spacers 40 can be dam-shaped structures and can be formed separately. Exemplary materials for the spacers 40 can include, for example, photosensitive material such as silane, acrylic, polyimide, siloxane, or epoxy. Thus, spacers 40 can be formed by photolithography and subsequent development without additional etching. Accordingly damage to the exposed transparent electrode 50 can be reduced.

In FIG. 1f, an organic electroluminescent layer 52 is then formed conformally in the organic electroluminescent area 45 and covers the exposed surface of the transparent electrode 50 and adjacent second passivation layer 38. The second passivation layer 38 can improve the adhesion of the organic electroluminescent layer 52 due to it has good hydrophilic property. According to various embodiments, the organic electroluminescent layer 52 can be an organic material, such as a small molecule material, polymer, or organic-metallic complex. The organic electroluminescent layer 52 can be formed, for example, by thermal vacuum evaporation, spin coating, dip coating, roll-coating, injection-filling, embossing, stamping, physical vapor deposition, or chemical vapor deposition, using a defined shadow mask (not shown).

Next, an electrode 54, such as a metal electrode, serving as the cathode electrode of the OLED is formed on the surface of the organic electroluminescent layer 52 in the predetermined organic electroluminescent area, for example, by sputtering or evaporation. To meet OLED cathode requirements, a material capable of injecting electrons into organic electroluminescent material is preferably used. Exemplary materials include, for example, low work function materials such as Ca, Ag, Mg, Al, Li, or alloys thereof.

In a conventional AM-OLED process, portions of a transparent electrode are formed directly on an insulating organic material such as PC403, available from JSR. Problems such as poor roughness of the transparent electrode caused by moisture uptake of the organic material, and organic contamination can occur in subsequent process tools such as a chemical vapor deposition (CVD) tool. Thus utilizing organic insulating material can be problematic.

However, according to various embodiments disclosed herein, the transparent electrode 50 is formed directly on a first passivation layer 36 of dielectric material with reduced moisture uptake. Surface roughness of the transparent electrode 50 is thus significantly reduced and the luminance efficiency and reliability of the electroluminescent devices are improved. For example, the average surface flatness can be less than about 2.5 nm, and in some cases less than about 2.0 nm. The organic electroluminescent layer 52 is formed in organic electroluminescent area 45 which defined by second passivation layer 38 and spacers 40, not only reduce moisture uptake but also avoid color blending problem.

Furthermore, the illustrated pixel structures in FIG. 1f which comprising a first passivation layer, a second passivation layer and a plurality of spacers having improved surface flatness can prevent unwanted current leakage or point discharge, and reducing moisture contamination, thus avoiding damage to the AM-OLED devices. Moreover, the use of underlying dielectric passivation layer provides opportunities to use CVD or other processes to form subsequent layers with lower fabrication cost. Tool contamination issues caused by conventional organic insulating materials is thus prevented, increasing process flexibility of the AM-OLED process.

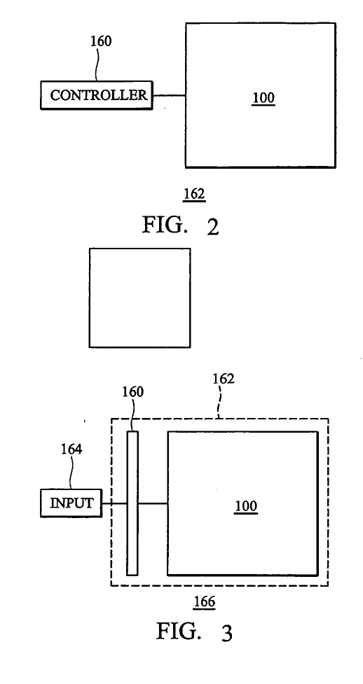

FIG. 2 shows a display device 162 comprising a display panel 100 incorporating an array substrate such as that shown in FIG. 1f. Display panel 100 can be coupled to a controller 160. The controller 160 can comprise source and gate driving circuits (not shown), controlling the display panel 100 for operation of the display device 162.

FIG. 3 is a schematic diagram illustrating an electronic device incorporating the display device 162 shown in FIG. 2. An input device 164 is coupled to the controller 160 of the display device 162 shown in FIG. 2 to form an electronic device 166. The input device 164 can include a processor or the like to input data to the controller 160 to render an image. The electronic device 166 may be a portable device such as a PDA, notebook computer, tablet computer, cellular phone, or a display monitor device, or a non-portable device such as a desktop computer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An array substrate for electroluminescent displays, comprising:
a substrate with at least one thin film transistor formed thereon;
a planarization layer overlying the substrate and the thin film transistor;
a first dielectric passivation layer having a contact hole therein, overlying the planarization layer and exposing a source/drain electrode of the thin film transistor;
a transparent electrode overlying a portion of the first dielectric passivation layer and conducting with the thin film transistor;
a second dielectric passivation layer overlying portions of the transparent electrode, exposing a portion of the transparent electrode; and
a plurality of spacers overlying portions of the second dielectric passivation layer, defining an organic electroluminescent area with an exposed transparent electrode.

2. (canceled)

3. The array substrate as claimed in claim 1, wherein the planarization layer comprises at least one of an oxide, a nitride, a carbide, or combinations thereof.

4. The array substrate as claimed in claim 1, wherein the transparent electrode comprises at least one of indium tin oxide (ITO), indium zinc oxide (IZO), aluminum zinc oxide (AZO), or zinc oxide (ZnO).

5. The array substrate as claimed in claim 21, wherein the first dielectric passivation layer comprises silicon oxide, silicon nitride, or combinations thereof.

6. The array substrate as claimed in claim 22, wherein the second dielectric passivation layer comprises silicon oxide, silicon nitride, or combination thereof.

7. A method of forming an array substrate for electroluminescent displays, comprising:
providing a substrate with at least one thin film transistor thereon;
forming a planarization layer over the substrate and the thin film transistor;
forming a first dielectric passivation layer with a contact hole over the planarization layer, exposing a source/drain electrode of the thin film transistor;
forming a transparent electrode over the first dielectric passivation layer and filling the contact hole;
forming a second dielectric passivation layer over portions of the transparent electrode, exposing a portion the transparent electrode; and
forming a plurality of spacers on the second dielectric passivation layer, defining an organic electroluminescent area with an exposed transparent electrode therein.

8. (canceled)

9. (canceled)

10. (canceled)

11. The method as claimed in claim 7 further comprising a step of forming an organic electroluminescent layer over the transparent electrode, wherein the organic electroluminescent layer comprises at least one of a small molecule material, a polymer, or an organo-metallic complex.

12. The method as claimed in claim 7, wherein the first dielectric passivation layer is formed by chemical vapor deposition.

13. The method as claimed in claim 7, wherein the second dielectric passivation layer is formed by physical vapor deposition (PVD).

14. The method as claimed in claim 7, wherein the first dielectric passivation layer comprises silicon oxide, silicon nitride, or combination thereof.

15. The method as claimed in claim 7, wherein the second dielectric passivation layer comprises silicon oxide, silicon nitride, or combinations thereof.

16. The method as claimed in claim 7, wherein the spacer is formed by photolithography and sequential development of a photosensitive material.

17. The method as claimed in claim 16, wherein the photosensitive material comprises silane, acrylic, polyimide, siloxane, or epoxy.

18. A electroluminescent display panel, comprising:
a substrate with at least one thin film transistor formed thereon;
a planarization layer formed over the substrate and the thin film transistor;
a first dielectric layer with at least one contact hole overlying the planarization layer;
a transparent electrode overlying the portion of the first dielectric layer adjacent to the contact hole and filling the contact hole;
a second dielectric layer overlying portions of the transparent electrode, exposing a portion of the transparent electrode;
a plurality of spacers overlying the second dielectric layer, defining an organic electroluminescent area with an exposed transparent electrode;
an organic electroluminescent layer overlying the exposed transparent electrode in the organic electroluminescent area; and
an electrode overlying the organic electroluminescent layer.

19. A display device, comprising:
an electroluminescent display panel comprising the array substrate of claim 1; and
a controller coupled to, and driving the electroluminescent display panel to render an image in accordance with an input.

20. An electronic device, comprising:
a display device of claim 19; and
an input device coupled to the controller of the display device to render an image.

21. The array substrate as claimed in claim 1, wherein the first dielectric passivation layer comprises inorganic materials.

22. The array substrate as claimed in claim 1, wherein the second dielectric passivation layer comprises inorganic materials.

23. The array substrate as claimed in claim 22, wherein the spacers have a thickness not less than 1 μm.

24. The array substrate as claimed in claim 22, wherein the spacers comprise a photosensitive material selected from a group consisting of silane, acrylic resin, polyimide, siloxane, and epoxy.
